(19) United States
(12) Patent Application Publication
(10) Pub. No.: US 2011/0309633 A1
(43) Pub. Date: Dec. 22, 2011

(54) Wind Auger

(76) Inventor: Edward Louis Padlo, Turlock, CA (US)

(21) Appl. No.: 13/165,735

(22) Filed: Jun. 21, 2011

Related U.S. Application Data
(60) Provisional application No. 61/357,369, filed on Jun. 22, 2010.

(51) Int. Cl. F03D 9/00; F03D 11/00

(52) U.S. Cl. 290/55; 416/198 R

(57) ABSTRACT

The purpose of the Wind Auger is to harness wind energy in a new and efficient manner. The wind auger utilizes a unique fin design and orientation to the wind to achieve superior performance in low to medium wind velocity locations. In addition, the simple, rugged structure of the design results in a quiet, stable performance in high wind situations. The combined effects of direct positive pressure, aerodynamic drag, and negative pressure greatly improve the performance of the Wind Auger in a wide range of wind conditions. This exponential improvement should shift the focus of design of wind turbines from a two-dimensional plane to a three-dimensional space.

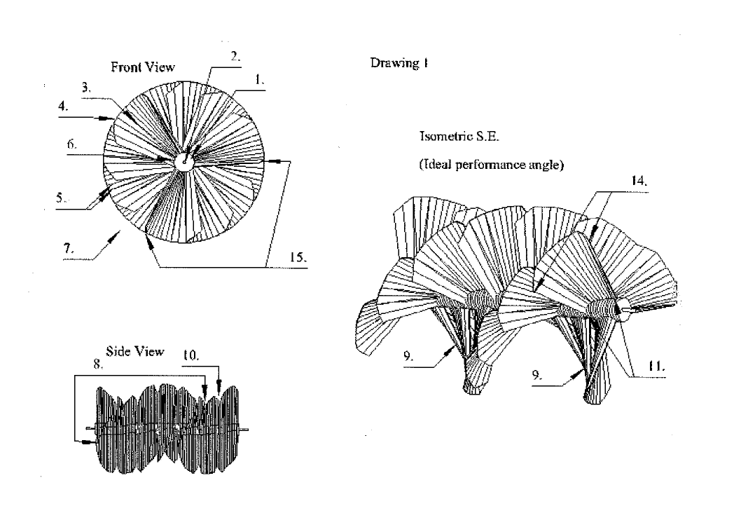

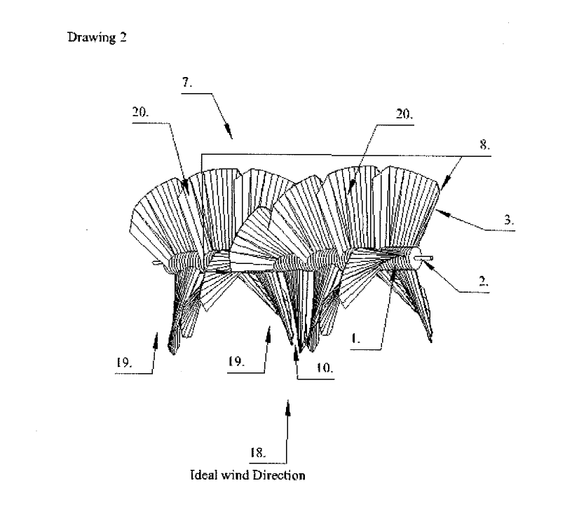

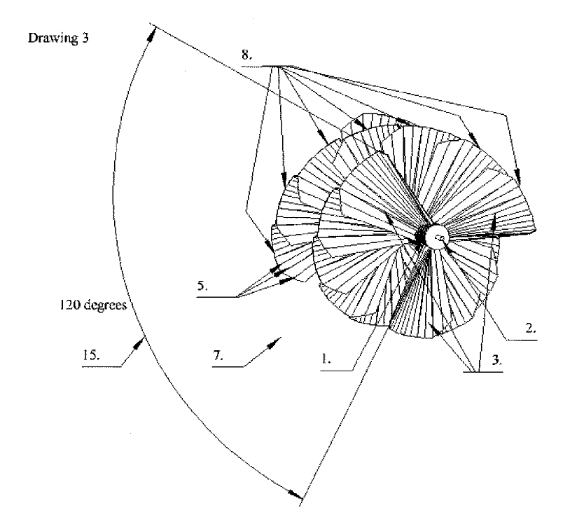

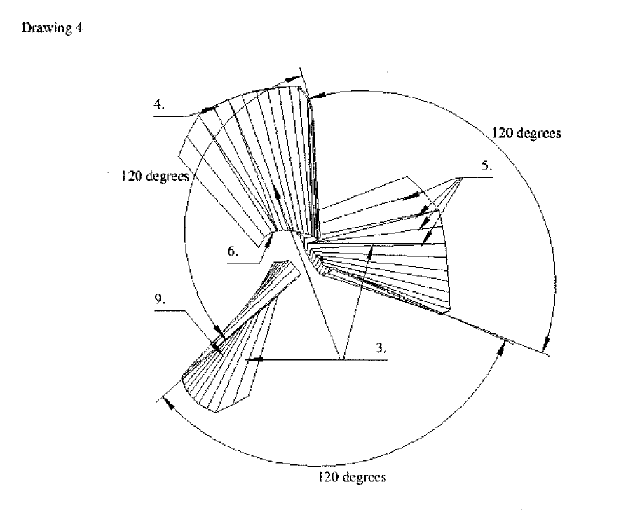

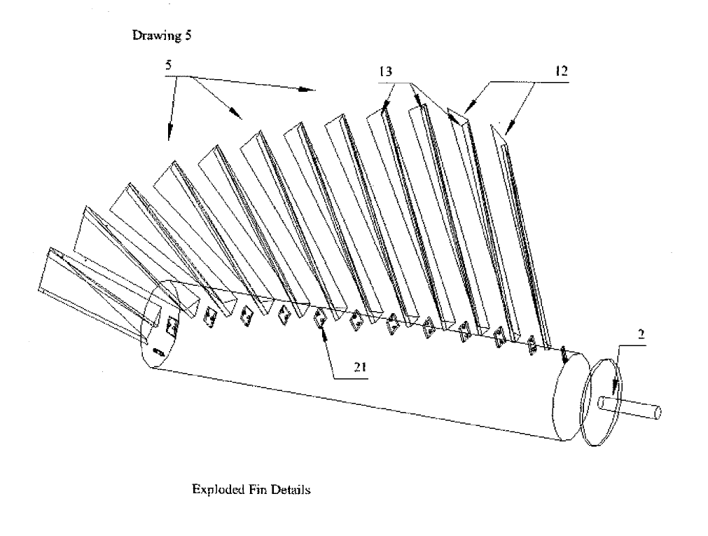

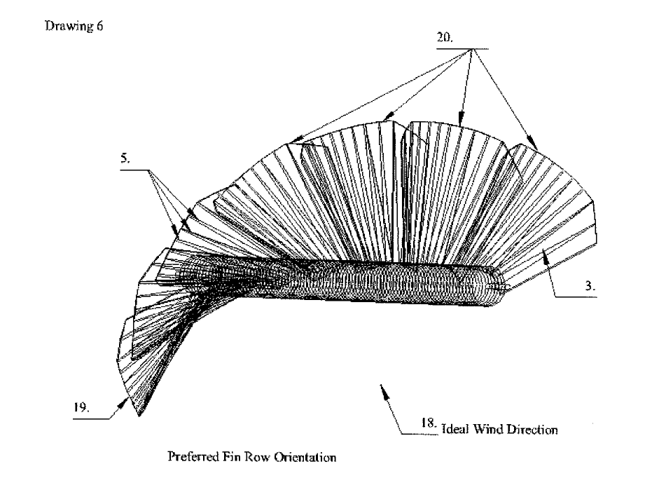

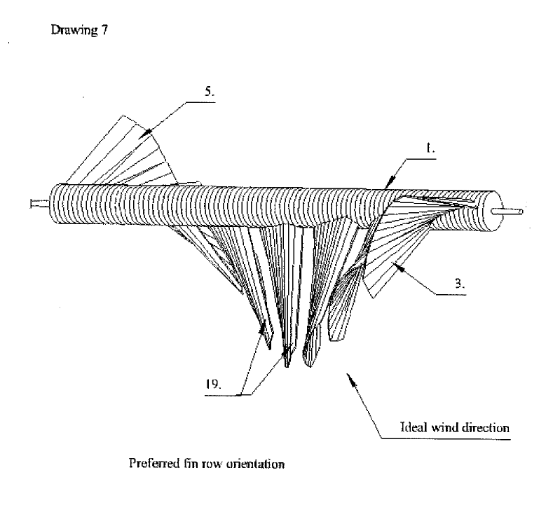

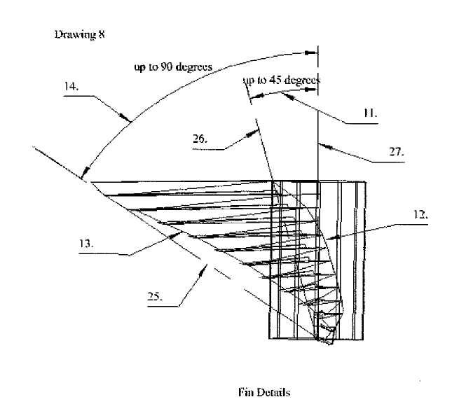

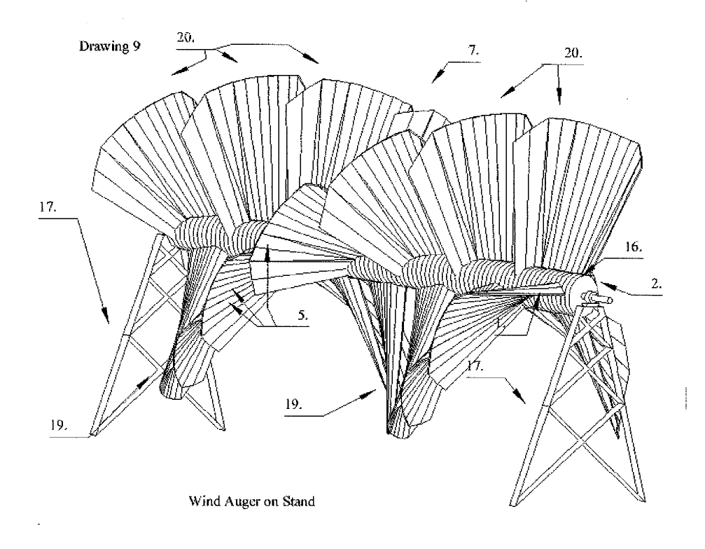

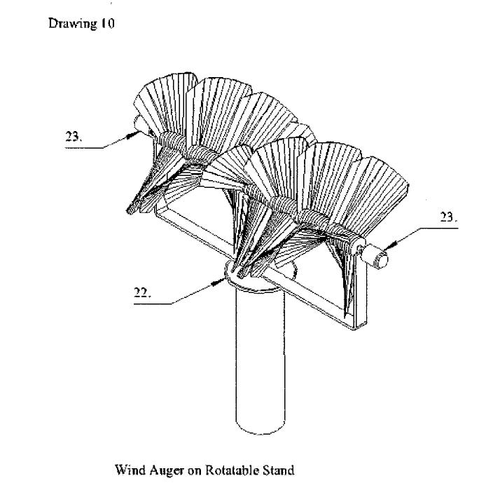

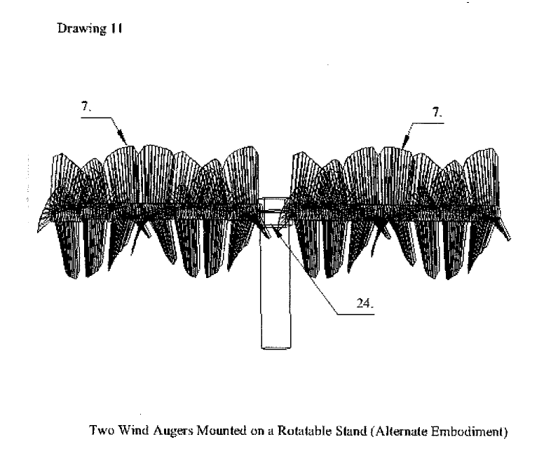

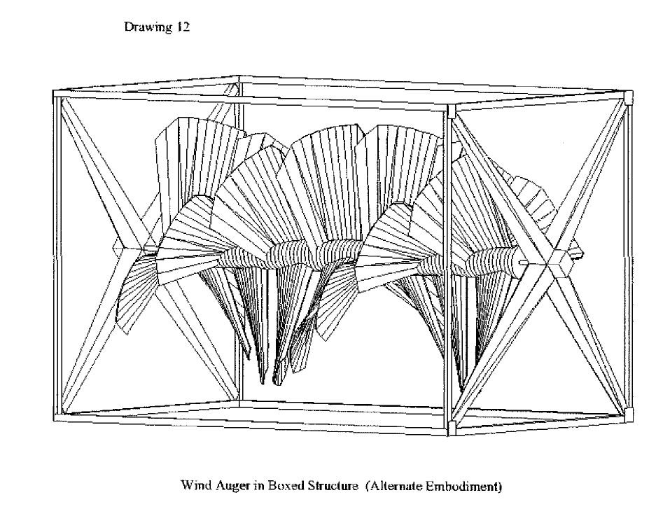

### REFERENCES CITED

This patent application claims the benefit of U.S. provisional patent application Ser. No. 61/357,369 to Edward Padlo on Jun. 22, 2010 and entitled “High torque helical wind turbine design for a wide range of wind conditions”.

### DESCRIPTION

The wind Auger is a high torque, three-dimensional horizontal axis wind turbine (HAWT) designed for a wide range of wind conditions

The device is comprised of the following:
Please refer to the drawings at the end of the example for a key to the reference numbers.
1. Cylindrical support member (CSM)
2. Rotor shafts and end plates
3. Wind auger Fins
4. Top edge of fins
5. Support ribs
6. Base or bottom edge of fins
7. Wind auger
8. Helical fin row orientation
9. Back or outer side of fin
10. Slot opening between fins
11. Angle and shape of top edge of fin in relation to the CSM
12. Outer facet of rib
13. Inner facet of rib
14. Angle and shape of top edge of fin in relation to the CSM
15. 120 degree equidistant spacing between rows
16. Bearings
17. Support stand
18. Ideal wind direction
19. Negative pressure or lift
20. Direct positive pressure
21. Mounting tabs
22. Rotatable structure
23. Power transmission unit
24. Dual mount power transmission unit
25. Chord of the non-linear shape of the top edge of the fins
26. Chord of the non-linear shape of the base of the fins
27. Horizontal axis of the HAWT

### BACKGROUND OF THE INVENTION

Harnessing energy from the wind has been a goal of civilized societies for centuries. modern innovations in turbine designs and power transmission components have allowed communities all over the world to benefit from the clean, abundant energy from the wind. However, many locations are not ideal for conventional wind turbines. Since the power generated by the wind is proportional to the velocity of the wind speed cubed, conventional wisdom has dictated the design trend in wind turbines towards medium to high wind efficient units. This has left most areas with low to medium wind averages with no practical alternative.

### BRIEF SUMMARY OF THE INVENTION

The Wind Auger is designed to extract energy from the wind in three distinct ways: positive pressure, aerodynamic drag, and negative pressure or lift. First, the fin surfaces of the Wind Auger facing the wind and perpendicular to its path receive a direct impact effect from the moving mass of air. The helical design of the fin rows and the unique orientation to the wind in which the Wind Auger operates most efficiently offer a large surface area exposed to direct positive pressure. Second, in the preferred embodiment, the ribs (5) of the fins create an aerodynamic drag effect when the wind strikes them and pulls them around the horizontal axis (27) of the HAWT. Third, the windward performance of the Wind Auger's fins that are rotating directly into the wind are the result of negative pressure or lift. The angle and orientation of the fins on the Wind Auger when the HAWT is turned out of the wind up to 45 degrees create a unique airfoil profile for each fin advancing into the wind during each rotation. Also, the interrelation of the offset fins on the Wind Auger is important. Wind tunnel tests have shown that the introduction of a slot (10) between airfoils may enhance the airflow in and around the combined airfoil profiles. However, if the slot is not large enough, air will not be able to pass through freely and it will become turbulent and inefficient; if the slot is too large, the beneficial effect of the combined air flows will be largely dissipated. The combined effects of direct positive pressure, aerodynamic drag, and negative pressure or lift are added empirically, greatly enhancing the performance of the Wind Auger in a wide range of wind conditions.

### BRIEF DESCRIPTION OF THE SEVERAL VIEWS OF THE DRAWING

Drawing 1: Front view, side view, and isometric south-east view

Drawing 2: Ideal wind direction in relation to the Wind Auger

Drawing 3: 15 degree front view

Drawing 4: Fin detail with circumferential orientation

Drawing 5: Exploded fin

Drawing 6: Single fin row during top rotation

Drawing 7: Single fin row during bottom rotation

Drawing 8: Fin details

Drawing 9: Wind Auger on stand

Drawing 10: Wind Auger on rotatable stand

Drawing 11: Dual mount rotatable structure

Drawing 12: Wind Auger in boxed structure

### DETAILED DESCRIPTION OF THE INVENTION

Most wind turbines require high sustained wind velocities to perform well, yet many areas of the world have average wind velocities of 5-15 mph. The Wind Auger's unique design develops high torque at relatively low wind speeds. In addition, it is known that the larger the machine the higher the performance value. Since wind turbines are a two dimensional machine, the only way to increase performance is to increase the area swept by the rotor blades. This is trending towards extremely large wind turbines that cannot be accommodated in most places. The Wind Auger's three-dimensional profile can accomplish the same level of performance within a much smaller area. The Wind Auger's diameter and length can be adjusted and manipulated to work in a wide range of situations.

The wind auger is a device configured and designed to harness wind energy. The wind auger is comprised of a cylindrical support member (CSM) (1) which extends the length of the device. It may be comprised of any hard, supportive material known in the art, including but not limited to metal, wood, or plastic. Rotor shafts (2) preferably, but not limited to, 1 inch-3 inch in diameter are mounted with end plates on both ends of the CSM to allow rotation around a horizontal axis. Three rows of fins (3) originating circumferentially 120 degrees apart, extend helically (8) along the length of the CSM. Each fin is permanently mounted to the CSM and may be comprised of any light, strong material known in the art, including but not limited to metal, plastic, wood, or fabric. The back sides (9) of the fins are preferably smooth and stream lined, enhancing their airfoil performance. The front sides of the fins are preferably ribbed, although they may be smooth like the backside. The ribs (5) in the preferred embodiment provide structural support for the fins and enhance the aerodynamic drag on the front side of the fins. Preferably the fins are attached to the CSM on mounting tabs (21), but may be attached any way known to the art.

The fins (3) of the wind auger are preferably connected to the CSM (1) in a helical pattern (8) along its horizontal axis. Any connections described in this application may include any known connections, including bolts, screws, adhesive, etc. The fins are attached at their base (6) to mounting tabs (21) on the C.S.M. The mounting tabs are permanently affixed on the CSM in specific spacing and orientation to hold the fin bases so that the chord (26) of the non-linear shape of the bases is offset up to 45 degrees (11) in relation to the horizontal axis (27) of the HAWT. The top edges of the fins are oriented so that the chord (25) of the non-linear shape of the top edges is offset up to 90 degrees (14) in relation to the horizontal axis of the HAWT. The different orientations of the bases and top edges of the fins create a twist in the profile of the fin which enhances their unique off wind performance.

The fins are preferably mounted in three identical helical patterns (8) oriented 120 degrees apart (15) spiraling along the horizontal length of the CSM. The leading edge of each fin is spaced circumferentially up to 60 degrees left or right from the trailing edge of the preceding fin of the same row. In the preferred embodiment, there is no overlap between successive fins in each row, however the leading edge of each fin may overlap the trailing edge of each preceding fin by up to 25 percent of said fin's surface area.

The rotor shafts (2) are preferably mounted in bearings (16) which support the CSM and allow it to rotate along its horizontal axis. Preferably, one or both of the rotor shafts are coupled to a power transmission unit (23) known in the art, including but not limited to pulleys, gear reducers, electric generators, or hydraulic pumps.

The CSM (1), rotor shafts (2) bearings (16), and fins, (3) are necessary elements of this invention. The optional elements all provide additional features and benefits as previously described. For example, the mounting tabs (21) provide support and aid in assembly. The ribs (5) provide structural integrity and contribute to aerodynamic drag. The support stand (17) provides support for the Wind Auger and maintains the proper orientation to the wind.

To make this invention, one could first provide the elements, including a CSM (1) rotor shafts and end plates (2), bearings (16), and fins (3). In the preferred embodiment the fins are formed by joining together the individual ribs (5). The shape of the outer facet (12) of the rib combines with the other ribs to form the smooth aerodynamic outer surface (9) of the fin. The inner facet (13) of the rib is formed to create a recessed area or pocket which enhances the aerodynamic drag along the inner surface of the fin. In another embodiment, the fin is stamped from aluminum sheets wherein the non-linear shapes of the tops and bases of the fins, as well as the twist formed by the difference between the two, is pressed into the sheets of aluminum. The ribs are then attached to the front side of the fins to provide support and enhance the aerodynamic drag. All of these elements could be connected using bolts, rivets, and/or screws to produce the Wind Auger as shown.

The preferred use of the Wind Auger (7) is to install it on a rotatable structure (22) with mechanical or electrical sensors to maintain the optimum orientation with the wind. In the preferred embodiment, the wind auger could be connected to a power transmission system (23) known to the art, including but not limited to pulleys, gear reducers, or electric generators.

In one embodiment, (drawing 9 and drawing 12) the Wind Auger (7) could be installed on a fixed support structure in a region with prevailing wind patterns. The Wind Auger has an ideal performance angle of up to 45 degrees left or right from front view. However, the wind auger has few dead zones and will perform to some degree at most angles. In another embodiment, (drawing 11) two Wind Augers could be mounted on a rotatable structure with a combined center mount dual power transmission unit (24). In another embodiment, the Wind Auger could be mounted on a transport trailer and moved to temporary locations. The Wind Auger could transfer its converted energy to electrical control panels on site through extension cords, or the wind auger could charge battery packs or compressed air tanks on transfer trailers to be unloaded later. In another embodiment, a Wind Auger with collapsible fabric fins (not shown) could be used in a portable model. They could collapse and store inside the CSM making for easy storage and transport It could be used by outdoor recreation enthusiasts in any number of applications including (but not limited to) campers, hikers, and boaters.

Regions or locations with low average wind speeds could benefit from the Wind Auger. Because of the unique design of the Wind Auger, multiple units may be installed in close proximity to each other, allowing for a high density of effective area in a wind zone. Because the ideal position is between 15-45 degrees out of the wind, wind augers can be aligned end to end to form a continuous line without a reduction in performance. Wind auger frame works could be linked together to parallel fences or property borders. They could line the peaks of factories or barns. They also could be incorporated into the designs of solar panel arrays.

### LIST OF DRAWINGS

Drawing 1: Front view, side view, & isometric south-east view
Drawing 2: Ideal wind direction
Drawing 3: 15 degree front view
Drawing 4: 3 fin detail
Drawing 5: Exploded fin
Drawing 6: 1 fin row top section
Drawing 7: 1 fin row bottom section
Drawing 8: Fin details
Drawing 9: Wind auger on stand
Drawing 10: Rotatable structure
Drawing 11: Dual mount rotatable structure
Drawing 12: Boxed structure

1. The Wind Auger is a horizontal axis wind turbine (HAWT) comprising:
A cylindrical support member (CSM) and a plurality of fins extending in a radial fashion from the CSM in a plurality of rows spaced circumferentially equidistant around the CSM, and extending helically along the horizontal axis of the CSM; wherein at least a portion of each said fin has a non-linear design and a means for affecting the drag coefficient on at least one side of said fin, wherein the Wind Auger can assume a unique angle of performance in relation to the prevailing wind direction to efficiently extract energy from the wind in three distinct ways:
by positive direct pressure, aerodynamic drag, and negative pressure or lift.

2. The HAWT of claim 1 wherein the said fins are permanently attached to the CSM in a radial orientation with the bases of the said fins positioned so that the chord of the non-linear shape of the base is offset up to 45 degrees from the horizontal axis of the CSM.

3. The HAWT of claim 1 wherein the said fins are permanently attached to the CSM in a radial orientation with the top edge of the said fins positioned so that the chord of the non-linear shape of this tips are offset up to 90 degrees in relation to this horizontal axis of the CSM.

4. The HAWT of claim 1 wherein the leading edge of each said fin in each row is oriented not more than 60 degrees left or right on the circumferential plane of the trailing edge of the preceding fin of the same row.

5. The HAWT of claim 1 wherein the leading edge of each said fin in each row overlaps the trailing edge of the preceding fin of the same row by a measure no greater than 25% of the width of the fin.

6. The HAWT of claim 1 wherein the said fins are adjustable in their orientation to each other, wherein each said fin can of shifted or adjusted in relation to each preceding or proceeding fin to facilitate optimal performance of the HAWT in varied wind conditions.

7. The HAWT of claim 1 wherein the said fins are expandable and/or contractible in their surface area, wherein each said fin can be enlarged or reduced to facilitate optimal performance of the HAWT in varied wind conditions.

8. the HAWT of claim 1 wherein the said fins are removable and/or collapsible, wherein each said fin can be easily removed or collapsed to enhance the portability of the HAWT.

9. The HAWT of claim 1 with a fixed support structure comprising of rotor shafts and bearings for each end of the CSM. Also including on at least one end a power transmission unit, brake, and generator.

10. The HAWT of claim 1 with a rotatable support structure with the ability to turn the HAWT to the unique optimal orientation with the wind. (15 degrees-45 degrees) comprising of rotor shafts and bearings for each end of the CSM, also including on at least one end a power transmission unit, brake, and generator.

11. The HAWT of claim 1 with a rotatable support structure with the ability to support two HAWTs 180 degrees apart from each other aligned on a central horizontal axis. Each HAWT connected mechanically and supportively on one end only to this support structure.

12. The HAWT of claim 10 wherein the support structure is expanded or enlarged on the lee side of the HAWT to form a partial shroud, so as to enhance the aerodynamic drag on the top edges of the fins as they rotate around the lee side of the HAWT.
